(19) United States
(12) Patent Application Publication
(10) Pub. No.: US 2002/0068144 A1
(43) Pub. Date: Jun. 6, 2002

(54) Towel with differential surfaces

(76) Inventor: Robert E. McCumber, Huntington Beach, CA (US)

Correspondence Address: Dennis W. Beech, LAW OFFICES OF DENNIS W. BEECH, 19900 Beach Blvd., Suite C-2, Huntington Beach, CA, 92648, US

(21) Appl. No.: 09/727,663

(22) Filed: Dec. 1, 2000

(51) Int. Cl. B32B 3/02; B32B 3/04; B32B 33/00

(52) U.S. Cl. 428/82; 428/88; 428/121; 428/122; 428/123

(57) ABSTRACT

The towel has differential surfaces such that the user may selectively use each for a particular purpose without later confusing for what each surface was used. The towel may be constructed of one or more layers of material with each exposed surface having a different color. In the instance of use of more than one layer the exposed layers may be constructed of different materials. An example is a towel for use in sports activities wherein one layer is suitable for drying and the opposite layer is suitable for placing on a chair or bench for protection.

### BACKGROUND OF THE INVENTION

1. Field of the Invention

This invention relates to towels structured for use in locations, environments or circumstances in which it is desirable to differentiate one towel surface from the opposite surface. The new device incorporates different coloring for opposite surfaces to allow the user a means to identify surfaces in order to select a surface for a particular use.

2. Description of Related Art

Towels are well known for use in various circumstances. Humans use towels for wiping or drying the body, for covering surfaces for purposes of sitting or other activity, for cleaning objects and for other endeavors. Often a towel is used in human activities both to cover a surface and to wipe or dry the body. An example of such use is in sports activities wherein the person uses the towel to cover a bench or chair while sitting and also uses the towel to wipe off sweat or to dry after washing. Towels are not normally structured such that a user can differentiate the surface used for wiping or drying from the surface placed in contact with an object covered. The person may have soiled one surface of the towel and use the same surface to cover an object or to dry after washing.

The present invention allows differentiation of the two surfaces of a towel to allow a user to selectively use each for a particular purpose. The towel may be constructed of one or more layers with opposite surfaces having different coloring. For multilayered towels each layer may be a different material as for example one exposed layer suitable for drying and the opposite exposed layer suitable as an object covering with each exposed layer having a different color

### SUMMARY OF THE INVENTION

One object of the present invention is improved structure for differentiation of each surface of a towel. Another object is to construct a towel suitable for use in differing circumstances.

In accordance with the description presented herein, other objectives of this invention will become apparent when the description and drawings are reviewed.

### BRIEF DESCRIPTION OF THE DRAWING

FIG. 1 illustrates a plan view of the towel.

FIG. 2 illustrates a side elevation view.

FIG. 3 illustrates an opposite side plan view of the towel.

FIG. 4 illustrates an end view.

### DESCRIPTION OF THE PREFERRED EMBODIMENT

The towel consists of two layers of material which are joined around their perimeter edges by a border material and stitching thereof. A single layer of material may be used with opposite surfaces having different colors and the perimeter edge finished using an edge securing method.

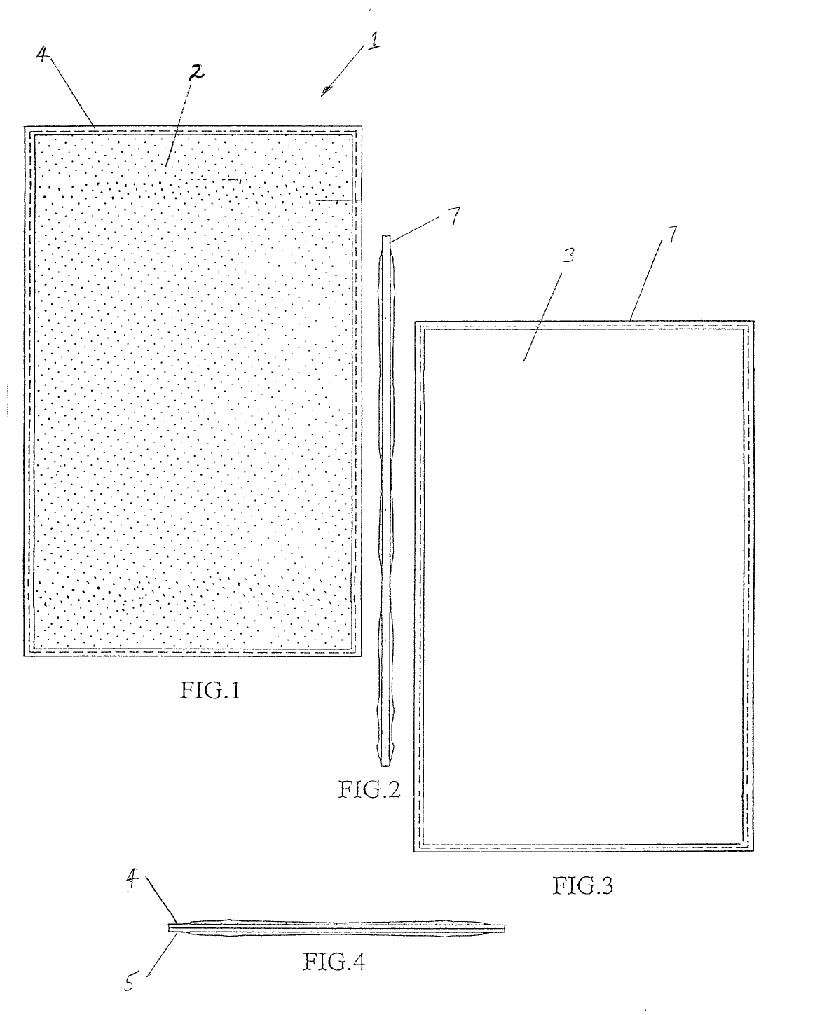

Referring to FIGS. 1 through 4, a towel (1) has two layers (2,3) of material. The two layers (2,3) are attached around their perimeter edges (4,5) by stitching (6). The layers may be stitched at their finished edges (4,5) or may have a border material (7) folded over the edges (4,5) and then the combination stitched.

The layers (2,3) may be fabricated of the same material or of different material. In either case the exposed surface of each is differently colored. In the use of different material for each layer (2,3), one layer may be a material most suited for wiping or drying the body and the opposite layer a material suited for placing on a surface for sitting such as a chair or bench. The same material may also be used for each layer (2,3) where drying and covering applications do not require a different material.

In application such as in human athletic activities, the user may use one side or layer (2,3) for drying the body after exercising. The opposite side may be placed on a chair or bench to protect it from moisture and to allow the sweating or drying person to sit on the bench. This promotes hygiene as individuals do not sit directly on a bench while perspiring thereby soiling the bench that others may wish to use. The layer of the towel (1) which the person uses for their own purpose such as drying also never contacts a bench or chair surface.

While the invention has been particularly shown and described with respect to the illustrated and preferred embodiments thereof, it will be understood by those skilled in the art that the foregoing and other changes in form and details may be made therein without departing from the spirit and scope of the invention.

I claim:

1. A towel with differentiable surfaces comprising:
a layer of material with each surface having a different color.

2. A towel with differentiable surfaces comprising:
a plurality of layers of material joined at their perimeter edges; and
opposite exposed layers having a different color.

3. The towel as in claim 2 wherein one opposite exposed layer is constructed of a material suitable for drying the human body and the opposite exposed layer is constructed of a material suitable for placement on an object surface.

4. The towel as in claim 2 wherein the perimeter edges are joined by stitching.

5. The towel as in claim 2 wherein a border material is folded over the edges and the combination joined.

6. The towel as in claim 5 wherein the combination is joined by stitching.
